(19) United States
(12) Patent Application Publication
(10) Pub. No.: US 2002/0029266 A1
(43) Pub. Date: Mar. 7, 2002

(54) Parallel processing architecture for alarm management network entities

(76) Inventors: Edwin Tse, Montreal (CA); Andre Godin, Laval (CA); Nicolas Gosselin, Blainville (CA)

Correspondence Address: ANDRE M. SZUWALSKI, Jenkens & Gilchrist, P.C., 1445 Ross Avenue, Dallas, TX, 75202-2799, US

(21) Appl. No.: 09/737,954

(22) Filed: Dec. 18, 2000

Related U.S. Application Data
(60) Provisional application No. 60/230,955, filed on Sep. 7, 2000.

(51) Int. Cl. G06F 15/173

(52) U.S. Cl. 709/224; 714/5

(57) ABSTRACT

In an Alarm Management System (AMS) a method and a management network entity for forwarding and processing Alarm Information (AI) such as alarm notifications and alarm lists. The management network entity, that may be an Alarm Collector (AC), receives the AI from an upstream network entity such as an Alarm Reporter (AR) or another AC in a Forwarding Process (FP) that relays the AI concomitantly to at least one downstream network entity and to a Verification Process (VP) that synchronizes the internal Alarm List (IAL) of the management network entity. The forwarding of the AI may include filtering the AI based on the preferences of the downstream network entity. The FP and the VP are separated processes, software modules or software applications, that may run in parallel on the same, or on separated processors.

### PRIORITY STATEMENT UNDER 35 U.S.C S.119(e) & 37 C.F.R. S.1.78

This non-provisional patent application claims priority based upon the prior U.S. provisional patent application entitled “Cascade Alarm Management System (CAMS) and Method”, application No. 60/230,955, filed Sep. 7, 2000, in the names of TSE Edwin, GODIN Andre, and GOSSELIN Nicolas.

### BACKGROUND OF THE INVENTION

1. Field of the Invention

The present invention relates to Event/Alarm Management Systems, and particularly to an Alarm Collector having an alarm processing function separated from an alarm forwarding function.

2. Description of the Related Art

Networks are widely employed nowadays in various areas of activity. Local Area Networks (LANs), Wide Area Networks (WANs), Public Land Mobile Networks (PLMNs) are just a few examples of the uses made of networks for providing new or improved services to users and subscribers. In order to insure its proper operation, each such network is typically monitored by a Management Network or Alarm Management System (AMS, also called Event Management System, EMS), which acquires and processes data related to the activity and/or faults that occur in the monitored network, or in the monitored network node(s). The nodes of the monitored network typically issue alarm notifications (also called event notifications) for various events taking place in the monitored network, such as for example call set-ups, radio cell selections, or hand-off failures in a PLMN. The alarms are further collected by the AMS and processed in a manner defined by the network operator for providing indications of the level of service quality given by the monitored network.

The typical functions of the AMS include collecting, processing and displaying alarm information concerning alarm notifications issued by various elements of the monitored network. Therefore, for providing these functions, a typical AMS may comprise:

a plurality of Alarm Reporters (ARs) which are the monitored network entities or corresponding functionality that create the alarm notifications upon detection of a predefined alarm or event notification trigger, such as for example a Base Station (BS) having a faulty transceiver;

a plurality of Alarm Consumers (ACons), which are network entities that process, analyze or display the alarm information created by the ARs, such as for example a computer-operated Graphical User Interface (GUI) part of a network administrator's alarm viewer terminal;

a plurality of alarm collectors (ACs) for collecting the alarm information from the ARs, or alternatively from other ACs, and for processing or further relaying the alarm information to other ACs or to the ACons, such as for example an alarm correlation network entity.

Typically, an AC or an ACons may register its interest for receiving certain types of alarm information with an upstream network entity, such as an AC and/or an AR. By “upstream” network entity it is meant a network entity that provides alarm information to another network entity, the downstream network entity, the alarm information typically travelling from one or more upstream network entities towards one or more downstream network entities. By registering its interest for receiving certain alarm information, the AC or the ACons provide to the given upstream network entity an alarm filter stating which alarms it is interested in receiving. Therefore, the upstream network entity (AC or AR) knows which Alarm Information (AI) should be transmitted downstream to the AC or the ACons. For example, in some implementations, such as in cascade configuration wherein the AI is created by upstream entities and “flows” downstream toward, typically, the ACons, upon receipt of the AI, an intermediate-level AC may be set to further relay the AI to yet another downstream AC, or to an ACons that registered its interest in having the AI.

The cascade configurations may be used in various implementations, such as for example but not limited to when the monitored network has a distributed configuration, like in situations wherein the monitored network is a Wide Area Network (WAN), a Public Land Mobile Network (PLMN), or a Public Switching Telephone Network (PSTN).

In many AMSs having a cascade configuration, an AC must perform a processing task and a forwarding task involving the received AI. A typical AC may receive the AI and may be set to correlate alarms contained in the AI, while also being required to push the AI further downstream to the next lower-level AC or ACons. Therefore, in cases of alarm storm, which involve a huge level of alarm modifications being received in a short period of time in a network entity, relaying the received AI downstream to the next lower-level AC or ACons requires an amount of calculations that oftentimes exceeds the processing limit of the given network entity, thus creating a non-negligible delay associated with that processing, delay during which the forwarding of the AI is postponed.

When the cascade system comprises a plurality of levels, such as for example 5 levels of ACs being implicated in the transmittal of AI between an AR and an ACons, the level of the cumulated delays become unacceptable. This is due to the fact that each AC may be set to first update/synchronize its Internal Alarm List (IAL) upon receipt of the AI, and only afterwards to further relay the AI to the next lower-level network entities. This procedure has a plurality of drawbacks: it is limited by the AC's processing performance, the delay of a complete AI path is the sum of the individual delays created by each AC processing, and the speed at which the AI is transmitted over the whole AI path greatly depends on the slowest AC in the chain. Furthermore, in some linear cascade configurations, if one AC's processing function fails because overloaded, the forwarding process of the AI is compromised.

Although it discloses no solution as the one described herein, U.S. Pat. No. 5,961,651 issued to Gittins et al. and International Patent WO99/44119 issued to Wollrath et al. bear some relation with the field of the present invention.

Gittins et al. disclose an event notification method in a computing system having a plurality of storage devices for notifying an application program of a change of state in a storage device so that corrective action can be taken. The notification module creates and maintains an event queue for storing events corresponding to changes in the state of the storage devices. The notification module further indicates to the application programs that events are in the queue, and the queue conditions are monitored by the notification for queue maintenance.

Wollrath et al disclose a method and apparatus for transporting behavior in an event-based distributed system, wherein the first process may register interest in an event occurring in another address space or physical machine, in such a way as to allow the subsequent notification of event's occurrence to obtain an object that includes methods that are to be run on receipt of the notification. When the notification is received, either by the first process or by some other identity designated by the first process to be the final point of the notification, the methods may be executed as specified by the first process.

It would be advantageous to have a method and system that overcome the above-mentioned drawbacks and limitations.

It would be of even further advantage to have a method and system that can reliably manage instances of alarm storms and that could rapidly and accurately process the incoming AI within a node, such as in a AC, without negatively affecting the AI forwarding performance.

### SUMMARY OF THE INVENTION

It is therefore an object of the present invention to provide in an Alarm Management System (AMS), a management network entity comprising a Forwarding Process (FP) receiving Alarm Information (AI) from an upstream network entity and responsive to the receipt of the AI, forwarding the AI to at least a downstream network entity. The management network entity further comprises a Verification Process (VP) receiving the AI from the upstream network entity, and synchronizing an Internal Alarm List (IAL) of the management network entity with the AI.

It is another object of the present invention to provide a method of managing Alarm Information (AI) in a management network entity of an Alarm Management System (AMS), the method comprising the steps of receiving in the management network entity the AI from an upstream network entity and upon receipt of the AI, concomitantly forwarding at least a part of the AI to at least one downstream network entity and synchronizing an Internal Alarm List (IAL) of the management network entity with the AI.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1.a (Prior Art) is a high-level block diagram of an exemplary prior art Alarm Management Network (AMS) 10 for performing alarm distribution and processing;

FIG. 1.b (Prior Art) is a flowchart diagram of a typical prior art method for processing alarm notifications; and

FIG. 2 is a high-level block diagram of an exemplary implementation according to a preferred embodiment of the present invention;

### DETAILED DESCRIPTION OF THE PREFERRED EMBODIMENTS

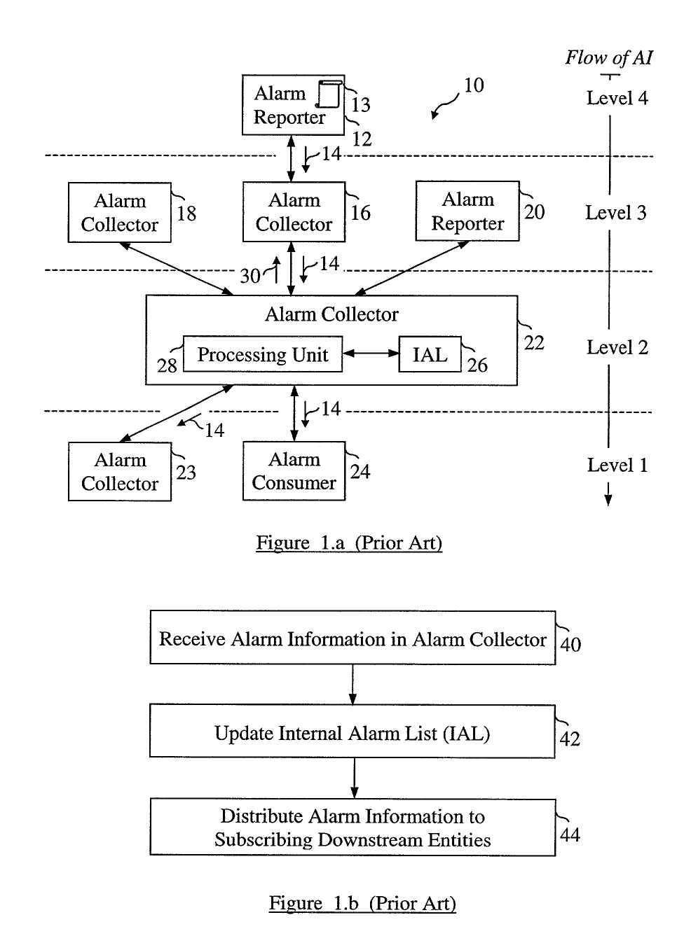

Reference is now made to FIG. 1.a (Prior Art), wherein there is shown a high-level block diagram of an exemplary prior art Alarm Management Network (AMS) 10 for performing alarm management, including alarm distribution and processing. In FIG. 1.a, the cascade AMS 10 comprises a plurality of levels 1-4, wherein the higher levels represent upstream entities that may create and forward Alarm Information (AI) for the downstream entities. For example, an Alarm Reporter (AR) 12 may create the AI 14 upon detection of a faulty device in the monitored node 13 (herein represented as being included in AR 12). The AI 14 may comprise one or more alarm notifications, or alternatively may comprise an Alarm List (AL) which may be a list of individual alarm notifications. The AR 12 may push the AI 14 to an Alarm Collector (AC) 16. At the same level as the AC 16, other network entities, such as for example another AC 18 and another AR 20 may exist. The network entities 16, 18, and 20 may further report AI, such as the AI 14, to yet other downstream entities, such as for example to the AC 22, which may do so for yet other downstream network entities, such as to another AC 23 and to another Alarm Consumer (ACons) 24. The AC 22 may comprise an Internal Alarm List (IAL) 26 for storing certain alarms. The AC 22 may further comprise a Processing Unit (PU) 28 for receiving, processing, and forwarding the incoming AI, such as the AI 14.

FIG. 1.b (Prior Art) shows a Prior Art method for performing alarm distribution and processing with a network entity such as the AC 22, when receiving AI such as the AI 14 from a cooperating upstream network entity, such as from AC 16. With reference being now made jointly to FIGS. 1.a and 1.b, the AC 22 may first send a registration message 30 to the upstream AC 16 for registering its interest in receiving alarm notifications that satisfy a particular criteria. Upon receipt of the registration message 30, the AC 16 sets up the mechanism for pushing alarm notifications satisfying the criteria of message 30 to the downstream entity, AC 22. Thus, when an AI satisfying the criteria of the registration message 30 is received, or otherwise become available, in the AC 16, it is further transmitted to the AC 22. Upon receipt of the AI 14, action 40 of FIG. 1.b, the AC 22 first updates/synchronizes its IAL 26 with the AI 14, action 42, and, assuming that the downstream entities AC 23 and ACons 24 have also registered their interest with AC 22 in AI alike AI 14, the AC 22 further relays the AI 14 to its cooperating downstream entities, action 44. Alternatively, if only a part of the AI 14 received in the AC 22 matches the criteria sent by the AC 23 and the ACons 24 to the AC 22, then it is only that part of the AI that is relayed downstream to the AC 23 and to the ACons 24 (scenario not shown).

The prior art method described herein is unreliable in circumstances wherein the AI 14 not only comprises one single alarm notification, but rather a great number of alarm notifications, or when the AI is very large. Such instances may often occur in today's solicited networks following, for example, an initial fault that engenders a chain reaction and creates yet additional faults, each triggering the creation of one or more alarm notifications. In such instances, an alarm storm is created and, in the example provided in FIG. 1.a and 1.b, the PU 28 of the AC 22 is overloaded when receiving the alarm storm, since it tries to process each incoming alarm notification. Only after having processed all the alarm notifications and having updated/synchronized its IAL 26 using each alarm notification's information, will the PU 28 further relay the proper AI to the downstream entities AC 23 and ACons 24. Therefore, it was observed that the prior art implementations are problematic when dealing with high volumes of alarm notifications, especially in cascade AMS environments.

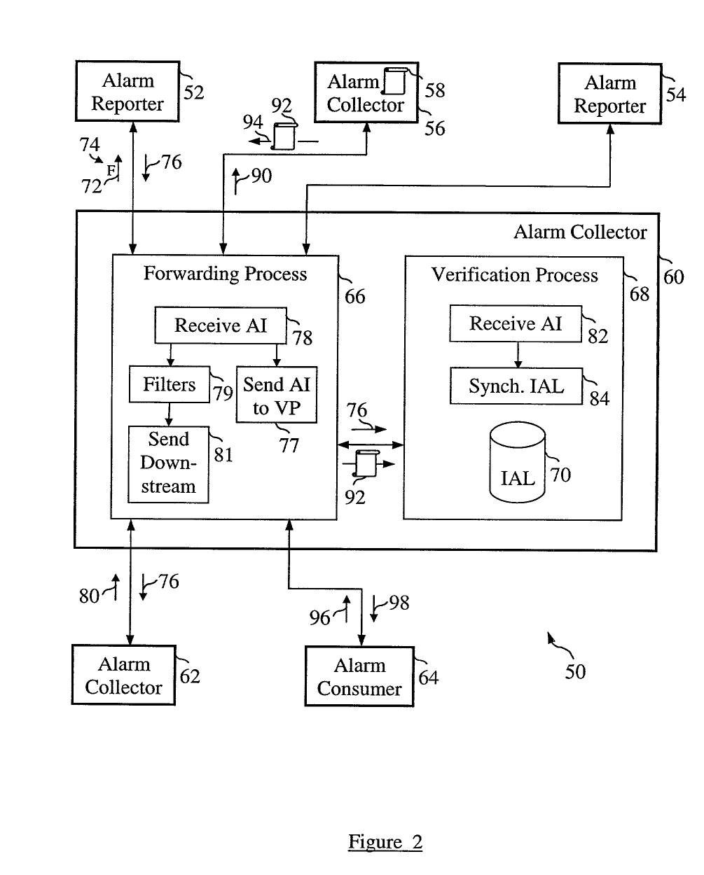

FIG. 2 is a high-level block diagram of an exemplary implementation according to a preferred embodiment of the present invention. Shown in FIG. 2 is an Alarm Management System (AMS) 50 having a plurality of higher-level network entities, such as for example two Alarm Reporters (ARs) 52 and 54 as well as an Alarm Collector (AC) 56 which may comprise an Internal Alarm List (IAL) 58 for storing Alarm Information (AI) of interest to the AC 56. The higher level network entities may send AI downstream to other downstream network entities, such as for example to another AC 60, which may be further connected to yet other downstream network entities such as for example to another AC 62 and to an Alarm Consumer (ACons) 64. According to a preferred embodiment of the present invention, the AC 60 may comprise a Forwarding Process (FP) 66 for forwarding incoming AI received from the upstream network entities 52, 56 and 54, to the downstream network entities 62 and 64. The AC 60 may further comprise a Verification Process (VP) 68 for performing operations involving its Internal Alarm List (IAL) 70, such as for example synchronizing the IAL 70, upon receipt of the AI from the upstream entities.

For better understanding of the invention, it is first assumed in the present example that the AC 60 is interested in receiving AI in the form of alarm notifications from the AR 52. Therefore, the AC 60 may send a subscribe message 72 that may comprise an alarm filter 74 for indicating the alarm notifications types the AC 60 is interested of receiving from the AR 52. Following the receipt of the subscribe message 72, the AR 52 will send to the AC 60 AI that matches the criteria of the alarm filter 74, each time AI becomes available to it, such as for example when it is created following a fault detection in the AR 52. For example, assuming that the AR 52 is a Base Station (BS) and that at the given moment one of its transceivers experiences a fault, responsive to the fault, the AR 52 creates an alarm notification 76 for reporting the fault. If the alarm notification 76 matches the criteria of the filter 74, then the AR 52 sends the alarm notification 76 to the AC 60. According to a preferred embodiment of the present invention, the alarm notification 76 is received in the FP 66, action 78, and transmitted to the VP 68 for synchronization of the IAL 70, action 77. At the same time, in the FP 66, the alarm notification 76 is processed in order to determine if it matches the subscriber filters registered with the AC 60 by any of the downstream entities 62 or 64, action 79. In the present example, it is assumed that only the AC 62 previously registered its interest with the AC 60 for receiving alarm notifications like the alarm notification 76 by sending a subscribe message 80 to the AC 60, the message 80 being of the same type as message 72 described hereinbefore. Therefore, in action 79 it is determined that the alarm notification 76 should be also sent to the AC 62, and not to the ACons 64. The FP 66 of the AC 60 then proceeds to the transmission of the alarm notification 76 to AC 62, action 81. Upon receipt of the alarm notification 76, action 82, the VP 68 synchronizes its IAL 70 with the information contained in the alarm notification 76, action 84. The synchronization of action 84 may comprise determining if the alarm notification 76 is related to an active alarm information stored in the IAL 70 and if so, updating of the IAL 70 using the information contained in the alarm notification 76, or alternatively if the alarm notification 76 is not related to any AI present in the IAL 70, adding the information contained in the alarm notification 76 to the IAL 70.

It can be seen from the above described example that the present invention concomitantly and independently processes the forwarding of the incoming alarm notifications toward the co-operating downstream entities in the FP 66 on one side, and the updating/synchronisation of IAL in the VP 68 on the other side. The forwarding and the processing of the incoming AI is performed in parallel, thus eliminating the delays created by the prior art sequential processing and forwarding of the AI. In this manner, the present invention solves the deficiencies of the prior art associated with the propagation delays of the alarm information, when for example, large amounts of alarm notifications are received by the network entities like the AC 60.

In other instances, a network entity such as for example the AC 60 may be interested in synchronising its IAL 70 with the AI of an IAL of an upstream entity such as for example with the AI of the IAL 58 of the AC 56. This situation may for example occur when the AC 60 loses confidence in the integrity of its IAL 70 content, or at predefined times as set up by network administrators, as well as in other situations. For requesting the AI of the IAL 58, the FP 66 of the AC 60 may send a GetAlarmList message 90 to the AC 56. Responsive to the receipt of the message 90, the AC 56 sends a copy 92 of its IAL 58 in a message 94, to the AC 60. Upon receipt of the message 94 in the FP 66 of the AC 60, action 78, the copy 92 of the IAL 58 is transmitted to the VP 68, action 77. Using the AI comprised in the copy 92, the VP 68 synchronises its own IAL 70. For example, for each alarm notification comprised in the IAL copy 92, the VP 68 may check if it locates a corresponding local alarm notification in IAL 70, and if so may update a local alarm notification with a piece of information comprised in its corresponding alarm notification from the copy 92. Otherwise, when no correspondence is found between particular alarm notifications of the copy 92 in the IAL 70, the VP 68 may add the particular alarm notifications to its own IAL 70. Concomitantly with the processing taking place in the VP 68, the FP 66 may independently forward the IAL copy 92, or at least a part of it, to downstream network entities that have previously registered their interest in at least certain types of alarms contained in the IAL copy 92. For example, for the present scenario, it is assumed that the ACons 64 previously registered its interest in receiving certain types of alarm notifications with the AC 60 by sending a subscribe message 96 similar to the one described hereinbefore. Therefore, when the FP 66 receives the IAL copy 92, action 78, it checks if any of the AI contained in the IAL copy 92, such as for example if any alarm notification of the IAL copy 92 matches the criteria of the filter provided in the subscribe message 96, action 79. All the AI that is detected to match the criteria of the filter provided message 96 is further transmitted to the ACons 64 in a message 98.

It can be seen again from the above-mentioned example that even in case wherein a complete IAL must be transmitted in a cascade AMS, the present invention provides a means for rapid alarm information forwarding combined with rapid synchronisation of the local IAL, by separating the forwarding process 66 from the verification process 68 and by running both in a parallel architecture.

According to a preferred embodiment of the invention, the IAL 70 of the AC 60, although herein designated as being an “Internal” Alarm List, may also be external to the AC 60, such as for example running on a different computer system and being connected to the AC 60. In such configuration it is to be understood that the designation “Internal” may refer only to the fact that the IAL 70 belongs to the AC 60.

According to a preferred embodiment of the invention, the FP 66 and the VP 68, although linked together for being able to exchange information as described hereinbefore, are separated processes, separated software modules or software applications that run over separated processors of a computer-operated network entity, such as the AC 60. Alternatively, the FP 66 and the VP 68 may also run onto separated computers connected with each other, or even as separated processes over the same processor of the same computer.

According to a preferred embodiment of the present invention, a plurality of alarm collectors or other network entities having like the AC 60 an FP 66 separated from the VP 68 may be connected in various configurations, including in a cascade configuration for reliably relaying and processing AI in an AMS.

According to yet another preferred embodiment of the invention, although terms such as alarm information and alarm list were used, it is to be understood that they are not limitative but rather comprise any type of alarm information, event information or any other types of information as it would be apparent for those skilled in the art.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. In an Alarm Management System (AMS), a management network entity comprising:
a Forwarding Process (FP) receiving Alarm Information (AI) from an upstream network entity and responsive to the receipt of the AI, forwarding the AI to at least a downstream network entity; and
a Verification Process (VP) receiving the AI from the upstream network entity, and synchronizing an Internal Alarm List (IAL) of the management network entity with the AI.

2. The management network entity claimed in claim 1, wherein the VP receives the AI from the upstream network entity through the FP.

3. The management network entity claimed in claim 1, wherein the AI comprises at least one alarm notification.

4. The management network entity claimed in claim 1, wherein the AI comprises a copy of an IAL of at least one upstream network entity.

5. The management network entity claimed in claim 1, wherein the upstream network entity is one of an Alarm Reporter (AR) and an Alarm Collector (AC).

6. The management network entity claimed in claim 1, wherein the downstream network entity is one of an Alarm Consumer (ACons) and an Alarm Collector (AC).

7. The management network entity claimed in claim 3, wherein for receiving the alarm notification from the upstream network entity, the management network entity sends a subscribe message to the upstream network entity for registering its interest in receiving the alarm notification.

8. The management network entity as claimed in claim 7, wherein the subscribe message comprises an alarm filter indicative of a type of alarm notifications the management network entity is interested in receiving form the upstream network entity.

9. The management network entity as claimed in claim 4, wherein the management network entity sends a GetAlarmList message to the upstream network entity for requesting the copy of the upstream network entity's IAL.

10. The management network entity as claimed in claim 1, wherein the AMS has a cascade configuration.

11. The management network entity as claimed in claim 2, wherein upon receipt of the AI, the FP distributes the AI to both the VP and to the at least one downstream network entity.

12. The management network entity as claimed in claim 1, wherein following the receipt of the AI, the FP filters the AI based on at least one downstream network entity alarm filter, and if at least a part of the AI matches a criteria of the filter, forwards the at least a part of the AI to the downstream network entity.

13. The management network entity as claimed in claim 1, wherein the FP and the VP are separate processes.

14. The management network entity claimed in claim 1, wherein the FP and the VP are separate software modules.

15. The management network entity claimed in claim 1, wherein the FP and the VP are separate modules run over separated processors.

16. A method of managing Alarm Information (AI) in a management network entity of an Alarm Management System (AMS), the method comprising the steps of:
receiving in the management network entity the AI from an upstream network entity; and
upon receipt of the AI, concomitantly forwarding at least a part of the AI to at least one downstream network entity and synchronizing an Internal Alarm List (IAL) of the management network entity with the AI.

17. The method claimed in claim 16, wherein the step of concomitantly forwarding and synchronizing the Internal Alarm List (IAL) of the management network entity with the AI, comprises concomitantly running a Forwarding Process (FP) for forwarding the AI to the least one downstream network entity and a Verification Process (FP) for synchronizing the (IAL) of the management network entity using the AI.

18. The method claimed in claim 16, wherein the AI of the upstream network entity is received in the FP of the management network entity, and the method further comprises the step of:
filtering the AI in the FP based on an alarm filter of the at least one downstream network entity, the filter being representative of AI the downstream entity is interested to receive;
wherein the forwarding of the at least a part of the AI to the at least one downstream network entity is performed if the at least a part of the AI matches criteria of the filter.

19. The method claimed in claim 16, wherein the VP receives the AI from the upstream network entity through the FP.

20. The method claimed in claim 16, wherein the AI comprises at least one alarm notification.

21. The method claimed in claim 16, wherein the AI comprises a copy of an IAL of at least one upstream network entity.

22. The method claimed in claim 16, wherein the upstream network entity is one of an Alarm Reporter (AR) and an Alarm Collector (AC).

23. The method claimed in claim 16, wherein the downstream network entity is one of an Alarm Consumer (ACons) and an Alarm Collector (AC).

24. The method claimed in claim 20, wherein for receiving the alarm notification from the upstream network entity, the management network entity sends a subscribe message to the upstream network entity for registering its interest in receiving the alarm notification.

25. The method claimed in claim 24, wherein the subscribe message comprises an alarm filter indicative of a type of alarm notifications the management network entity is interested in receiving form the upstream network entity.

26. The management network entity as claimed in claim 21, wherein the management network entity sends a GetAlarmList message to the upstream network entity for requesting the copy of the upstream network entity's IAL.

27. The management network entity as claimed in claim 16, wherein the AMS has a cascade configuration.
